(19) United States
(12) Patent Application Publication
(10) Pub. No.: US 2012/0136849 A1
(43) Pub. Date: May 31, 2012

(54) Dynamic Selection of Point-Of-Interest Search Services

(75) Inventors: Karthigesu NIRANJAN, Ottawa (CA); Stéphane Luc BÀRBARIE, Gatineau (CA)

(73) Assignee: Research In Motion Limited, Waterloo (CA)

(21) Appl. No.: 12/955,337

(22) Filed: Nov. 29, 2010

(51) Int. Cl. G06F 17/30

(52) U.S. Cl. 707/708; 707/E17.108

(57) ABSTRACT

A method and a system for point-of-interest search is disclosed. A search request including a location information acquired by a mobile device at a location defined by the location information is received at a server. A search query is formulated using the search request and the location information. The search query is sent to a plurality of search engines and search results are received from the plurality of search engines and aggregated based on the search context.

### BACKGROUND

The present disclosure relates to selection of search services, and more specifically, to location based selection of point-of-interest (POI) search services.

Many of today's mobile devices are equipped to provide location information on a real time basis. Cell-ID may be used to estimate the location of a mobile device by using a cell-ID of a cell tower. More sophisticated mobile devices incorporate Global Positioning System (GPS) technology. GPS uses a satellite network to transmit signals to individual GPS receivers on the ground which then triangulate receiver coordinates based on these signals. The mobile device may then convert the coordinates to other formats, such as a pointer on a map, to be displayed to the user.

Many mobile devices today, for example, the smart phones, are also equipped with web browsers or other graphical presentations that allow users of the mobile devices to search for information from the Internet. These mobile graphical presentations are suited for displaying web pages on the relatively small screens of the mobile devices without sacrificing too many of the functionalities.

The graphical presentations and location determination capabilities of a mobile device lead to the development of point-of-interest (POI) searching capabilities on a mobile device.

In the context of a traditional desktop search, the search is based mostly on a specific keyword or keywords. The user may search for websites with content or information that can help them make a better decision. The user may research for a school or work project, looking for information about a particular person or institution.

POI searches using web connected mobile devices have different requirements. The sensitivity of mobile search to location and time is important as a user conducting a mobile search has more immediate and distance sensitive needs.

In the recent years, search engines and web sites that provide search results based on a particular location have come into existence. These online search engines can narrow down the search results by providing a list of POIs within a given proximity of the given location.

These types of search engines and websites increase the relevance of the search results for the mobile device user by narrowing down the results based on a specific location, which addresses the location or time specific search results that POI search usually requires.

Many search engines and websites that offer POI searching capabilities on a mobile device are limited to using a fixed list of data providers and categories. Typical user interfaces usually require the user to select a single provider and category and perform the query based on that information only.

The problem with the existing websites and search engines is that the mobile search user is faced with the task of finding and deciding which data providers or search engines to use, especially if their search is based on something interesting to do near a specific location. If the user wants to search for business listings or points of interest close by such as parks, historical sites or landmarks, they would have to go to a specific mapping search engine. If the user wants to search for a list of restaurants close by that has other users' reviews, they would have to go to another search engine or data provider. If the user wants to search for events close by they would have to go to yet another search engine or data provider. This problem is also exacerbated since the mobile search is time sensitive. Another problem is that these data providers and search engines have differing layouts and search result information formats that makes the search disorganized.

Generally, a user of the mobile device is a customer of a carrier providing the wireless service. The carrier may desire to provide preferred search engines to the customer so that the advertising revenue can be shared between the carrier and the search engines. However, currently it is not possible for a carrier to configure the availability of search engines for providing location based search results.

In light of the above and other existing problems, there is a need for a system and method which provides a mobile device user to request POI searches from multiple search engines and websites in a concurrent way, where each search engine may have its own set of search categories that is selected by the user, the carrier or a third-party server.

### BRIEF DESCRIPTION OF THE DRAWINGS

These and other features of the disclosure will become more apparent from the following description in which reference is made to the appended drawings wherein:

FIG. 1 depicts a block diagram of an exemplary embodiment of a POI search system in accordance with the present disclosure;

FIG. 2 depicts a block diagram of a server in the exemplary POI search system in FIG. 1;

FIG. 3 depicts a process flow chart illustrating the POI search through a server and a plurality of search engines;

FIG. 4 illustrates a flow chart of the POI search using a plurality of search engines in one embodiment of the present disclosure;

FIG. 5 depicts an alternative diagram of a portion of the flow chart in FIG. 4;

FIG. 6 (A) and (B) depict two schematic presentations of a mobile device interface; and

FIG. 7 depicts a functional block diagram of a mobile device on which embodiments of the present disclosure may be implemented.

### DETAILED DESCRIPTION OF PREFERRED EMBODIMENTS

In accordance with one embodiment of the present disclosure there is provided a method for point-of-interest search. A search request is received at a mobile device. A search query using the search request and a location information is formulated, and sent to a search resource selector. Search results are received and then displayed.

In accordance with another embodiment of the present disclosure there is provided a search aggregation server for point-of-interest search. The server comprises a location based request receiver receiving a search request including a location information acquired by a mobile device at a location defined by the location information. A search resource selector of the search aggregation server formulates a search query using the search request and the location information. A search resource provider the search aggregation server sends the search query to a plurality of search engines. A search result interface the search aggregation server receives search results from the plurality of search engines; and a search result aggregator the search aggregation server aggregates the search results based on the search context.

In accordance with another embodiment of the present disclosure there is provided a mobile device for point-of-interest search comprising: a client application accepting a user input and originating a search request, the search request including a location information acquired by a mobile device at a location defined by the location information; and a transceiver receiving aggregated search results; wherein the server formulates a search query using the search request and the location information and sends the search query to a plurality of search engines, receives search results from the plurality of search engines; and aggregates the search results.

In some embodiments, the search resource selector sends the search query to a plurality of search engines.

In some embodiments, the search resource selector resides in a server, further comprising sending the search query to a plurality of search engines.

In some embodiments, the location information is included in a search context.

In some embodiments, the search results are aggregated based on the search context.

In some embodiments, the search context includes a user selection.

In some embodiments, the aggregated results are provided to the mobile device.

In some embodiments, the search request is input by a user input.

In some embodiments, a subset of search engines is defined.

In some embodiments, the subset of search engines is defined by a carrier.

In some embodiments, a subset of categories is defined.

In some embodiments, the search request originates from a client application running on the mobile device.

In some embodiments, the location information is cached location data.

In some embodiments, the server complements the search context.

In this specification and the appended claims, the singular forms “a,” “an,” and “the” include plural references unless the context clearly dictates otherwise. Unless defined otherwise, all technical and scientific terms used herein have the same meaning as commonly understood to one of ordinary skill in the art to which this disclosure belongs.

The term “search request” is intended to describe any request sent by a mobile device and received by a carrier or a server. The search request may include or be accompanied by a location information or other search context.

The term “search query” is intended to describe any query sent by a server, for example an aggregation search server, to one or more search engines.

The term “search engine” is intended to describe a server or other machines operating algorithmically to provide information to a user. A search engine may be a data provider providing information from different search resources.

The term “result” or “search result” or “answer” is intended to describe any information which may be provided responsive to a search query or a search request. A result includes, but is not limited to, any of an advertisement, a link to a web page, a message of any sort, image, audio, text, games, interactive media and software.

The term “search aggregation” or “aggregated search” is intended to describe running a search query across multiple search engines or data providers and aggregating the results to take advantage of the different searching and indexing algorithms/methodologies of the search engines or data providers. The search aggregation may be run automatically.

The term “search resource” or the term “resource” is intended to describe any source of information which may be used to obtain a search result. A search resource includes automated and/or human-assisted systems, any repository of information, and any type of media and/or systems which may provide information. A resource may be a provider or source of item(s) and/or service(s). For example, a resource may provide an item such as a ringtone, a media file (e.g., audio, video, images, games, etc.), information such as news, lyrics, song titles, translations or any other type of information. A resource may be automated, and/or may utilize the assistance of a person(s).

The term “Global Positioning System”, and its abbreviation “GPS” are intended to expansively include any satellite-based navigation-signal broadcast system, and would therefore include other systems used around the world. Furthermore, references herein to “GPS” are meant to include Assisted GPS and Aided GPS.

The term “point-of-interest”, and its abbreviation “POI”, are intended to describe a specific point location that may be useful or interesting. A point-of-interest may be specified by a GPS, at minimum, through the latitude and longitude of the POI. A name or description for the POI is usually included, and other information such as altitude or a telephone number may also be attached.

A POI may be defined by location-determining systems, for example but not limited to, a radiolocation subsystem that determines its current location using radiolocation techniques. In other words, the location of the mobile device can be determined using triangulation of signals from in-range base towers, such as used for Wireless E911. Radiolocation techniques may include but not limited to: angle of arrival (AOA) which entails locating the caller at the point where signals from two towers intersect; time difference of arrival (TDOA), which uses multilateration like GPS, except that the networks determine the time difference and therefore the distance from each tower; and location signature, which uses “fingerprinting” to store and recall patterns, such as multipath, which mobile phone signals exhibit at different locations in each cell. Radiolocation techniques may also be used in conjunction with GPS in a hybrid positioning system.

The POI may further be determined by calculating the relative distances between the device and multiple Wi-Fi hotspots or a signature of the Wi-Fi network.

The term “carrier” is intended to describe any communication service provider, specifically wireless service provider. The wireless service provider may use any known and future wireless transmission technology which may include, but is not limited to, Code Division Multiple Access (CDMA), Time Division Multiple Access (TDMA), Frequency Division Multiple Access (FDMA), Orthogonal FDMA (OFDMA), Single-Carrier FDMA (SC-FDMA). wireless local area networks (WLANs), broadcast networks. CDMA may include, but is not limited to, cdma2000, Universal Terrestrial Radio Access (UTRA). TDMA may include, but not limited to, technology such as Global System for Mobile Communications (GSM). An OFDMA system utilizes Orthogonal Frequency Division Multiplexing (OFDM) and sends modulation symbols in the frequency domain on orthogonal subcarriers, and may be implemented in technologies such as E-UTRA or E-UTRAN.

The term “search context” is intended to describe characteristics which is associated with a POI. Search context includes but are not limited to demographic, geographic, affiliations, areas of interest, historical actions, preferences, memberships, associations, etc. Search context may also include the dynamic configuration of the search engines and/or search categories selected by the user and/or the carrier and/or server. Search context may include factors which systematically determine the form, meaning, appropriateness or translation of a POI search request for a particular query/set of search term(s) and/or the background information that enhances understanding of technical and business environments to which the search results relate, or the set of facts or circumstances that surround a situation or event. Search context may be specified explicitly, wherein the user specifies the search engines and/or categories, or derived implicitly, for example based on the location of the mobile device.

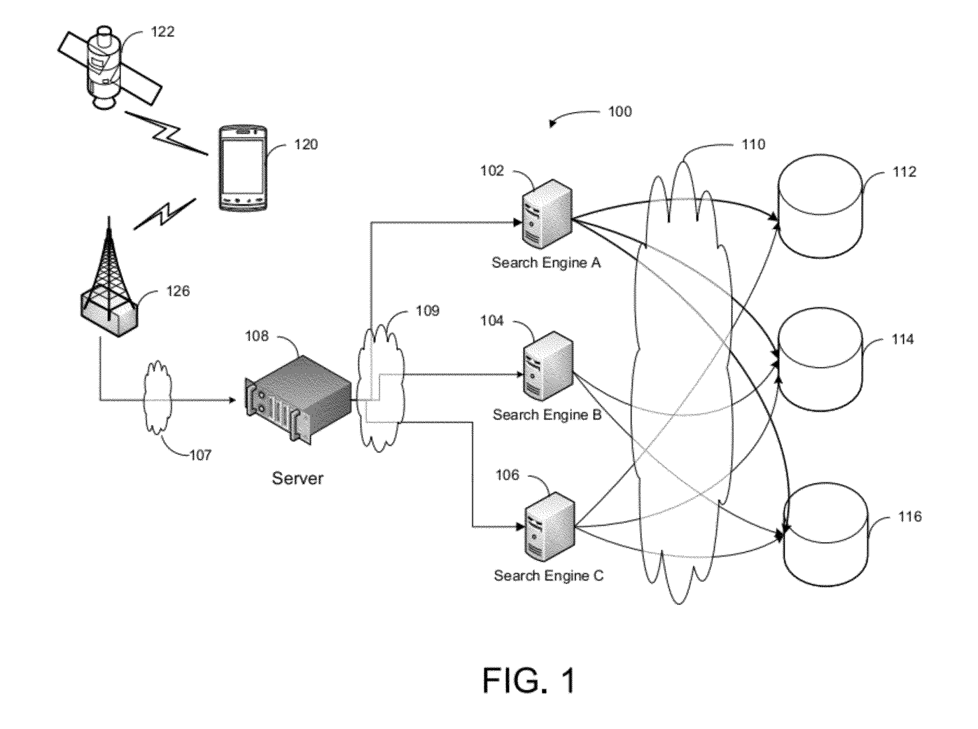

Referring to FIG. 1, a block diagram of an exemplary POI service provider system 100 is depicted according to one embodiment of the present disclosure.

In the POI system 100, the search results are originated by search engine A 102, search engine B 104, and search engine C 106 at the direction of a server 108. The server 108 may communicate with the search engines 102, 104,106 through a network 109. The search results are then aggregated at the server 108 in the search context to take advantage of the different searching and indexing algorithms/methodologies of the search engines 102, 104, 106.

The search engines 102, 104 and 106 access via the network 110 or otherwise, the search resources 112, 114, 116.

The search resources 112, 114, 116 may include web sites, search engines, data repositories, human agents, directory services, meta search engines, content aggregators, or other information resources available via the network 110, or combinations thereof. In one embodiment, the resources 112, 114, 116 are publicly available information resources.

A mobile device 120 may acquire its location information through a plurality of GPS satellite 122; other radiolocation techniques such as angle of arrival which locates the mobile device 120 at the point where signals from two towers intersect; time difference of arrival, which uses multilateration similar to GPS, but the mobile device 120 determines the time difference and therefore the distance from each tower; location signature, which uses “fingerprinting” to store and recall patterns (such as multipath) which mobile phone signals exhibit at different locations in each cell; calculating the relative distances between the device and multiple Wi-Fi hotspots, receiving a signature of a Wi-Fi network and a combination thereof.

The user of the mobile device 120 may access the server 108 through the carrier 126, using the location information of the mobile device 120, to initiate an aggregated search of at least a subset of search resources 112, 114, 116, the server 108 then causing the search engines 102, 104 106 to search the search resources 112, 114, 116, or at least a portion thereof. The carrier 126 may communicate with the server 108 through a network 107.

The networks 107, 109, 110 may include any public or private, wired or wireless network or combinations thereof. In one embodiment, the networks 107, 109, 110 are the same network, such as the Internet. In an alternate embodiment, the network 109 between the search engines 102, 104 and 106 and the server 108, includes a private network, such as a virtual private network implemented via a public network or other proprietary network, while the network 110 between the search engines 102, 104 and 106 and the search resources 112, 114, 116 is a publicly accessible network, such as the Internet. It will be appreciated that the network 110 may also be a private or, proprietary network in implementations of the disclosed embodiments that are wholly within a private enterprise.

In one embodiment, the POI search is provided by the carrier 126 to users who are customers. In another embodiment, the carrier 126 may provision the availability of the search engines 102, 104 and 106 through the server 108. In another alternative embodiment, the carrier 126 may allow third party advertisers to pay for the display of advertisements to users who use the system 100, such as by having their advertisements inserted into the search results. Alternatively, the carrier 126 may earn income based on users who select/click on particular search results, e.g. “pay-per-click” or “click thru” revenue. In yet another alternative embodiment, the carrier 126 may provide basic services to users in accordance with the disclosed embodiments and further offer cross-sell, up-sell services and/or additional features or options on a fee basis. Yet alternatively, the carrier and the search engines 102, 104 and 106 may share advertising revenues. In one embodiment, the server 108 may provide a website or web service executing on a web server and accessible by users via a network.

The server 108 may accept and process POI search requests in HTML, XHTML, WML or other similar markup languages submitted through the graphical presentations such as browsers of the mobile device 120. The browsers on the mobile device may be able to handle one or more of the above-mentioned markup languages. In addition, the server 108 is adapted to parse and extract location information and search terms embedded in those POI search requests and use the extracted information to define a search query. In one embodiment, the server 108 may include a web server and a database in communication with each other. In general, the server 108 is responsible for providing location based aggregated search results, to the mobile devices users upon their requests.

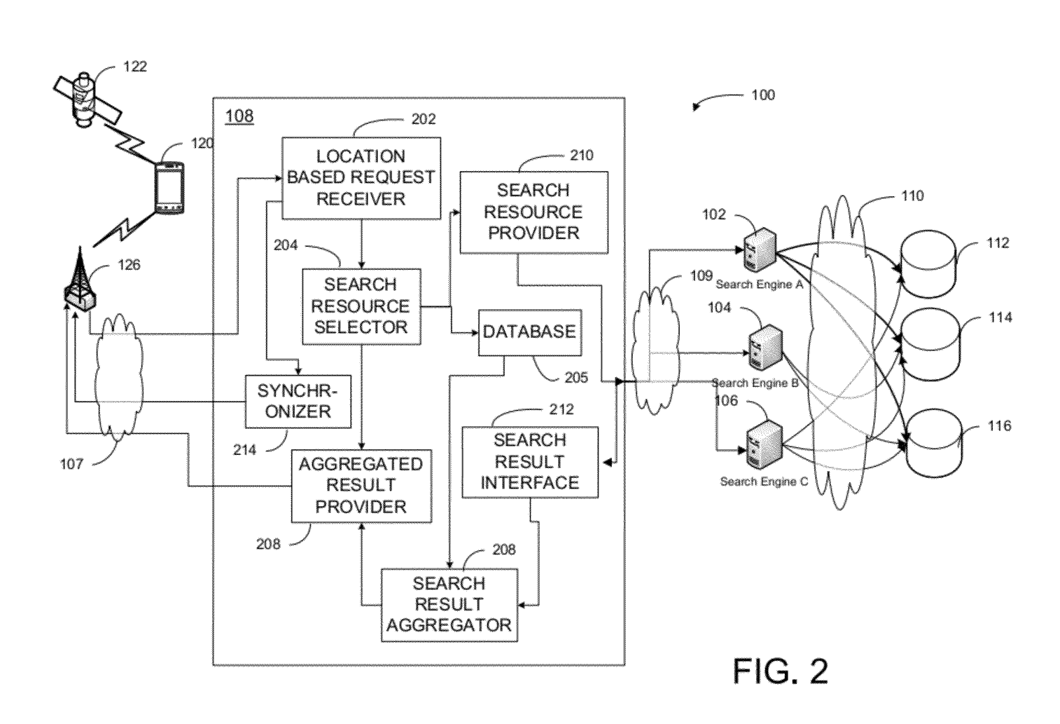

Referring to FIG. 2, the server 108 includes a location based request (LBR) receiver 202, search resource selector 204 and aggregated result provider 206. It will be appreciated that the server 108 may be implemented in hardware, software or a combination thereof, and that one or more of the components thereof may be combined or, alternatively, subdivided into other functional units, to implement the described functionality. In one embodiment the described functionality is implemented in computer program logic stored in a memory device, such as a computer memory or computer storage device, and executable by one or more processors to implement the described functionality. For example, the described functionality may be implemented on a web server as one or more network accessible web pages coupled with suitable back-end logic.

The POI search request receiver 202 receives an POI search request to initiate a search from a mobile device 120, generally through a carrier 126 and remote from the server 108, the POI search request comprising the location information of the mobile device 120 and at least one query. The POI search request may be further combined with the search context characterizing the information a user is seeking. Alternatively, a POI search request may indirectly specify a search term, such as by referencing a previous search request or selecting from a list of predefined POI request. In other embodiments, utilizing a client application provided to the mobile device 120, the POI search request receiver 202 further receives the request to initiate the search from the client application, the client application being operative to receive a query to initiate the search from the user, such as via a graphic user interface, and provide the request to the POI search request receiver 202. The POI search request may be provided to the POI search request receiver 202 using the HTTP protocol, such as via a HTTP POST operation. It will be appreciated that other HTTP mechanisms or other suitable protocols may be used.

The server 108 also includes a search resource selector 204 coupled with the POI search request receiver 202 and operative to identify, based on the POI search request, a first subset of the plurality of search engines 102, 104, 106 to which a POI search request should be directed based on the at least one search term. In one embodiment, the search resource selector 204 is coupled with a database 205 storing identifications of available search engines 102, 104, 106, such as by key-word association. The search resource selector 204 may extract search terms from the POI search request and compare them with the keyword associations in the database 205, thereby retrieving the associated search engines 102, 104, 106 identifications. Alternatively, other methodologies may be used to relate the POI search request to a select set of search engines 102, 104, 106. In one embodiment, the carrier 106 may provision the server 108 to select a subset of search engines. In another embodiment, the server 108 may be further operative to determine which of the plurality of search engines 102, 104, 106 are likely to provide relevant results in response to a search query for the at least one search term. For example, the database 205 may further store characteristic information relating to each of the available search engines 102, 104, 106, such as their topical scope or known likelihood to provide information relevant to particular topics. Using keyword comparison or other analysis, the POI search request is related to these characteristics to determine those search engines 102, 104, 106 that are more likely to provide relevant results. It will be appreciated that database 205 may actually be internal or external to the server 108.

The user of the mobile device 120 may specify, or the server 108 may otherwise derive from the user, a search context in which to constrain the POI search request, either to constrain the selection of search engines 102, 104, 106 and/or filter the received results. Alternatively, the server 108 may be self-limited to a particular search context, such as people, entertainment, automobiles, real estate, etc. and thereby the user need not explicitly specify a search context as their POI search request implicitly specifies the search context. Particular search engines 102, 104, 106 may be limited to certain self-imposed contexts based on their topical scope and the server 108 may be aware of these limitations, such as via the database 205. In one embodiment, the search resource selector 204 is further operative to identify, via the received location information and other information such as key words, tags or other explicit or implicit specifications, a search context and determine, such as by using the database 205, which of the plurality of search engines 102, 104, 106 are likely to provide relevant results in response to a search query for the at least one search term in relation to the search context. For example, the database 205 may store identifications of search engines 102, 104, 106 along with specifications of the contexts of the information they provide or provide access to. In another example, the database 205 may store carrier provisioning information regarding the selected search engines. The search context may include, in addition to the geographic context based on the location information, a demographic context, topical context, other context characterizing what results the user would likely perceive as relevant, or combinations thereof. For example, the search context may include a characteristic of a people, a culture, a society, a community, a mutual interest of a people, culture, society or community, or combinations thereof.

Based on the search context including the location information, the server 108 may identify a goal of the user in performing their search and modify the search to achieve, i.e. cause the search engines to return results that more closely approximate the user's goal. In particular, the server 208 may identify a goal of the user in performing their search and select the subset of search engines that are most likely to provide results that closely approximate or meet the user's goal. This further improves the user experience, for example but not limited to, more relevant results require less post processing and/or interpretation, less utilization of available bandwidth, such as a limited bandwidth connection, by targeting only those search engines 102, 104, 106 likely to provide the desired results. Such identification may be based on rules or other parameters which may be easily maintained at the server 108. In one embodiment, the search resource selector 204 is further operative to modify the at least one search term to attempt to cause the identified first subset of search engines 102, 104, 106 to provide relevant results in response thereto. The search resource provider 210 is further operative to provide the modified at least one search term back to the search engines 102, 104, 106, whereby the originated search query include the modified at least one search term. Effectively, the server 108 leverages a centralized knowledge base to enhance, clarify and refine the user search queries to attempt to cause the selected search engines 102, 104, 106 to provide more relevant results than if the user had individually accessed each search engines 102, 104, 106 on their own.

The server 108 further includes a search resource provider 210 coupled with the search resource selector 204 and operative to provide at least a portion of the identified first subset of search engines 102, 104, 106 to the carrier 126. The provision of the identified search engines 102, 104, 106 causes, in response thereto, the mobile device 120 via the optional carrier 126 to originate a POI search request, based on the at least one search term, for transmission to at least one of the search engines 102, 104, 106 of the identified first subset. For example, the user of the mobile device 120 may transmit a POI search request to the server 108 and cause the search engines 102, 104, 106 to provide their results in response.

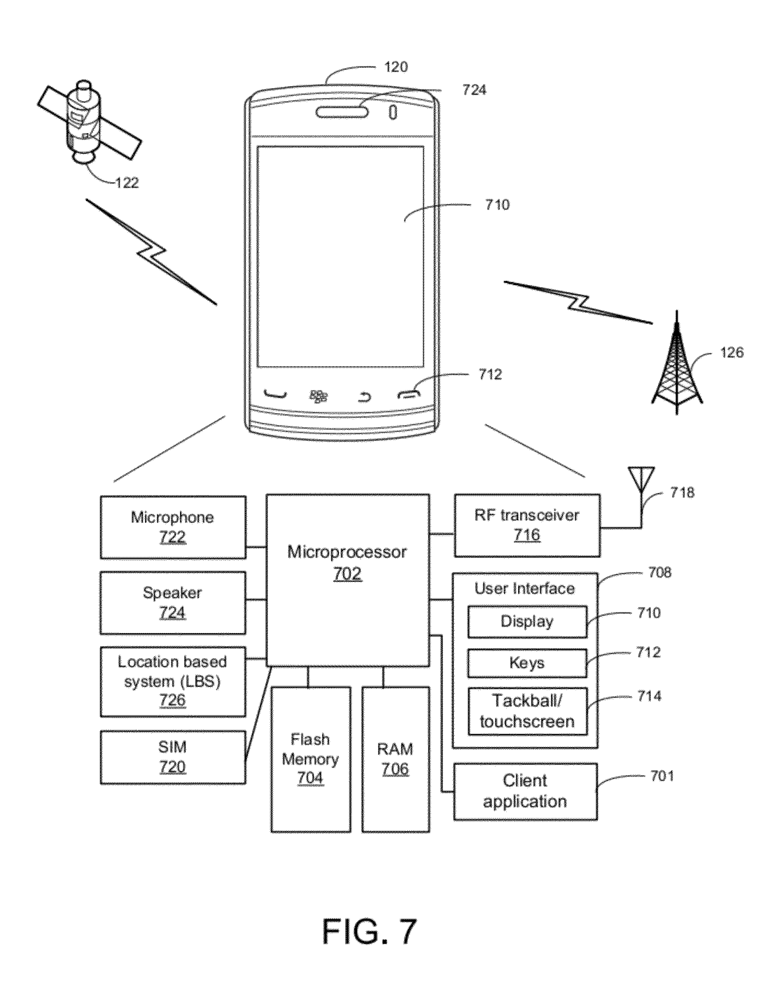

As discussed above, and referring to FIG. 7, the disclosed embodiments may utilize a client application provided to the mobile device 120 in advance of, or at the time of, the initiation of a POI search request by the user. The client application 701 is responsive to the server 108 to originate the requisite POI request. For example, the client application 701 may interact with the server 108, optionally via the carrier 126, to transmit the POI search request and cause the search engines 102, 104, 106 to provide results responsive thereto. The client application 701 may further serve as an interface between the user and the server 108 and may further operate to present the results, optionally modified by the server 108, returned in response to the POI search request. The client application 701 may be any software program suitable to implement the disclosed functionality and may include a separate executable program, a browser executable, such as plug-in or module, or program code, instructions or commands provided by the server. In one embodiment, the client application 701 is a browser plug-in or module which is accessible at any time by the user, such as via a pop-up menu, to receive a POI search request in accordance with the disclosed embodiments, such as while the user is viewing or otherwise surfing various websites or pages. In one embodiment, the server 108 includes a client application provider operative to provide a client application 701 to the mobile device 120 to be executed thereon, the client application 701 being operative to cause the mobile device 120 to originate each of the POI request. The client application provider may be a browser accessible web page from which the user can download the client application. Alternatively, the client application provider may automatically provide the client application 701 to the mobile device 120 at the time of, or in advance of the user initiating a POI search request to the server 108. It will be appreciated that the client application provider may distribute the client application via other means, such as by electronic mail or otherwise include it with other applications that the user may download, with or without the user's explicit or implicit permission. Where the client application 701 has previously been provided to the mobile device 120, the client application provider may, at the time that the user initiates a POI request, verify that the mobile device 120 has the latest version of the client application 701 and, if not, provide an updated version of the client application 701 to the mobile device 120.

Subsequent to server 108 transmitting the search queries to the identified search engines 102, 104, 106, the search engines 102, 104, 106 will generate results responsive thereto. In one embodiment, the server 108 may receive and post-process the results of the search to modify, enhance or augment the results, such as to provide value-added services or otherwise further tailor and/or aggregate the results to meet or more closely approximate the user's goal or constrain the results within the explicitly or implicitly specified search context. Results may be augmented with additional results retrieved from the server itself, such as from the database 205 or other internal database or from additional network resources.

In one embodiment, the server 108 includes a search result interface 212 operative to receive, such as from the search engines 102, 104, 106, redirect or intercept, a result based on the search query from each of the search engines 102, 104, 106 of the identified first subset having received the search query. In one embodiment, the server 108 includes a search result aggregator 208 coupled between the search result interface 212 and aggregated result provider 206 and to process the received result such as by modifying the results, enhancing results, augmenting the results or combinations thereof. For example, the received results may be processed to remove duplicative results, remove advertisements or other irrelevant content, reformat the results to more clearly present them to the mobile device 120, or combinations thereof. In one embodiment, the search result aggregator 208 is coupled with the database 205 or another database from which additional results may be derived to enhance or augment the results received from the search engines 102, 104, 106. For example, the server 108 may operate as a search engine or search resource itself wherein the database 205 stores the information that is catalogued, cached or otherwise indexed.

In one embodiment, the carrier 126 may use, for technical or economical reasons, a second, different subset of the search engines 102, 104, 106 other than the subset used by the search resource selector 204 through the identified first subset of the search engines 102, 104, 106. For the second subset of the search engines may be only available in certain countries or geological regions, or the carrier may wish to share the advertisement revenues with the subset of the search engines.

For example, the carrier 126 may configure the available search engines to be search engine A 102 and search engine C 106, while the server 108, through the search resource selector 204, is provisioned to query the search engine A 102 and search engine B 104. In this example, only search engine A 102, among the search engines 102, 104, and 106 generates the search result to the server 108.

In addition, the search result interface 212 may receive at the server 108, via the search engines 102, 104, 106 and the at least one other search engines 102, 104, 106, a result based on the search query from each of the search engines 102, 104, 106 of the identified first subset having received the search query. The search result aggregator 208 coupled with the search result interface 212 may further process the received results as described above, such as by aggregating the results from the various search engines 102, 104, 106, and the aggregated result provider 206 coupled with the search result aggregator 208 may then be further operative to provide the processed results to the search engines 102, 104, 106 for presentation to the user.

The server 108 may further include a synchronizer 214 which ensures that the mobile device 120 only presents the search engines that are currently supported by the server 108. When a request is received at the server 108, the location based request receiver 202 determines if the request is a search request or a synchronization request. The server 108 then compares the configuration provided by the mobile device 120 with its own configuration and returns an adjusted configuration back to the mobile device 120.

When the server 108 receives a search request, the server 108 performs a validation of the mobile device configuration and determines if the configuration is out of sync. The server 108 then performs the search query, aggregates the results and sends the response back to the mobile device 120 along with a flag to notify that the mobile device 120 needs to initiate a synchronization request.

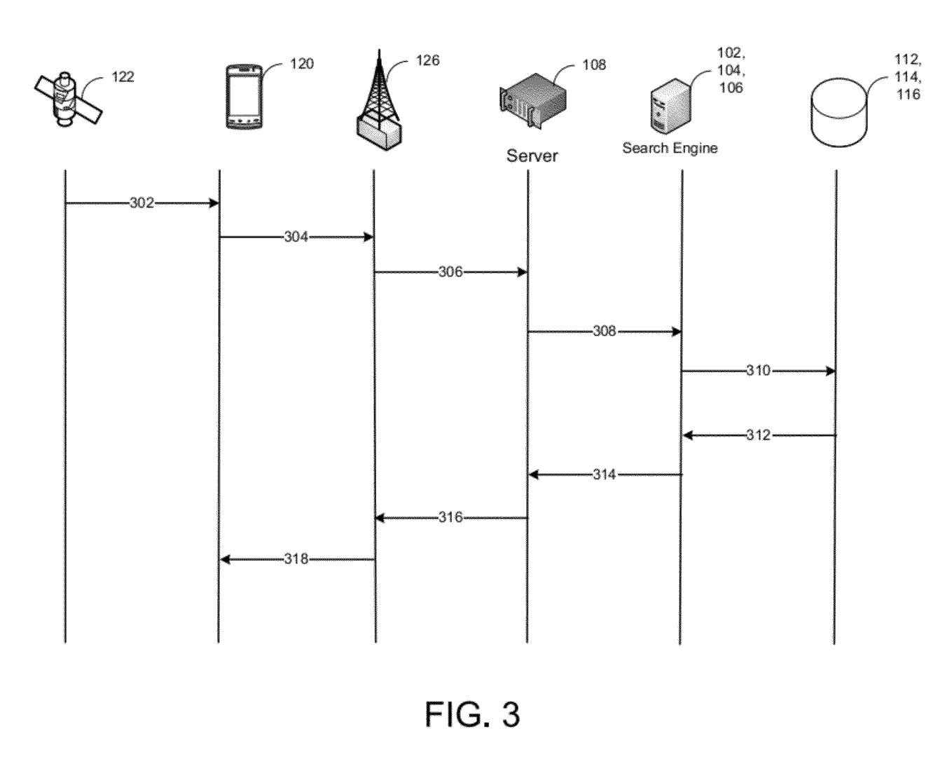

FIG. 3 is a process flow chart that illustrates the POI search through a server and a plurality of search engines, in accordance with an embodiment of the present disclosure. In operation, the mobile device 120 acquires location information at a POI through one of the location determining mechanism as described above, for example through a GPS system 302. A user of the mobile device 120 selects an option on a graphic presentation, for example, a browser on the mobile device, for example, by clicking on the mobile device. The user may select a subset of the search engines, or a subset of the search categories.

The POI search request may be first received by the carrier 304, then by the server 306. The server 108 then sends 308 the POI search to a plurality of search engines 102, 104, 106.

The search engines 102, 104 and 106 access 310, via a network or otherwise, the search resources 112, 114, 116 to obtain 312 the search results. The search results are presented 314 to the server 108 by the search engines. The server 108 then aggregates the POI search results based on the search context and sends 316, 318 the aggregated POI search results to the mobile device 120, optionally through the carrier.

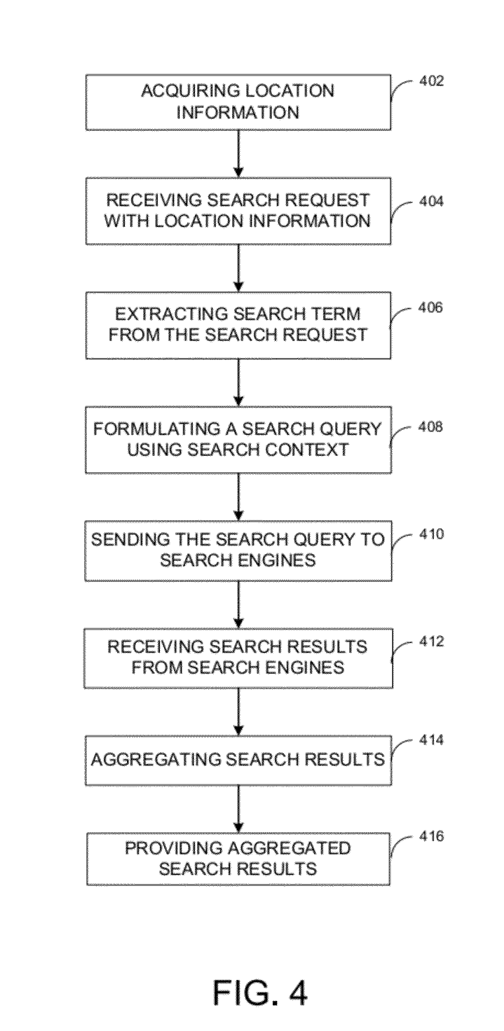

FIG. 4 illustrates a flow chart of the POI search using a plurality of search engines in one embodiment of the present disclosure.

In operation, at 402, the mobile device determines the real time location. In general, as described above, the mobile device communicates with an external location-based service and obtains real-time location data of the mobile device,

In one embodiment, the location is determined through a GPS system which allows the mobile device to communicate with the GPS satellites to obtain latitude, longitude and altitude coordinates of the current position of the mobile device. In another embodiment, a Wi-Fi compatible location determination module obtains location information based on its distance from Wi-Fi hotspots. The location information may also be obtained using Cell ID of the closest cellular tower, or using MS-Based or MS-Assisted technologies. If the mobile device 120 is outside the location based service network or fails to obtain the current location data for any other reasons, the mobile device may still submit a location-independent search via the mobile network.

If the location is determined successfully, the mobile device captures the location information for use with the user query as described below. If the location determination is unsuccessful or unnecessary for any reason, the mobile device may use a cached location value for that particular search or for multiple searches.

At 404, the user of the mobile device may navigate a search page of a graphical presentation, for example, a browser. Optionally, this search page may be the default page of the browser. In one embodiment, the search page includes a text field for the user to type in a search string, such as “gas station,” “hotel,” or “restaurant”. In other embodiments, the search page may also display a number of the most frequently searched items as icons or links for direct user selection. Preferably, a text field or other means for receiving user defined search string is available on the search page because this gives the user the freedom to search for anything on the Internet rather than limit them to only a few search categories. In one embodiment, the search page includes the selection of search engines.

At 406, after the location information is acquired and search request is received, the server 108 may then extract the search term and location information from the POI search request.

At 408, the server 108 may reformulate the query based on the search context if necessary, and send 410 the query to a plurality of search engines.

In one embodiment, the server 108 may be indexed relative to the location information so that the latitude and longitude data can be easily converted to street address to be used in a search. In one embodiment, even if the user does not specifically request for a location-sensitive search, the server automatically sorts the search results based on their proximity to the user location based on the search context, for example, the location information it receives.

At 412, results from the search engines are received at the server 108.

At 414, these results are aggregated at the server in the search context. The search results from each of the search engines may be combined to produce an aggregated result, based on the location information obtained from the mobile device. In another embodiment, the results may be derived from the union of the result sets from the search engines.

At 416, the server 108 sends the search results back to the mobile device via the wireless network, optionally through the carrier. Upon receiving the search results, the browser automatically refreshes the page to display the retrieved information. The search results may also each include a link to a more detailed page on the particular result.

Embodiments of the disclosure provide a manageable solution for mobile device users to conduct location based searching of multiple search engines by reducing the required amount of user interactions. Specifically, the disclosure utilizes the existing location information of a mobile device and automatically incorporates the location information in a search context without significant user input. Accordingly, in one embodiment the required user action only includes opening a user interface on the mobile device and selecting the search option. In another embodiment, the required user action includes modeless entry of a search string followed by an agreement to use location information when performing a search such the modeless entry triggers the search process. The user may optionally enter a search term to better define the scope of the search. To that end, the present disclosure gives users the freedom to customize their searches by specifying search engines and search categories.

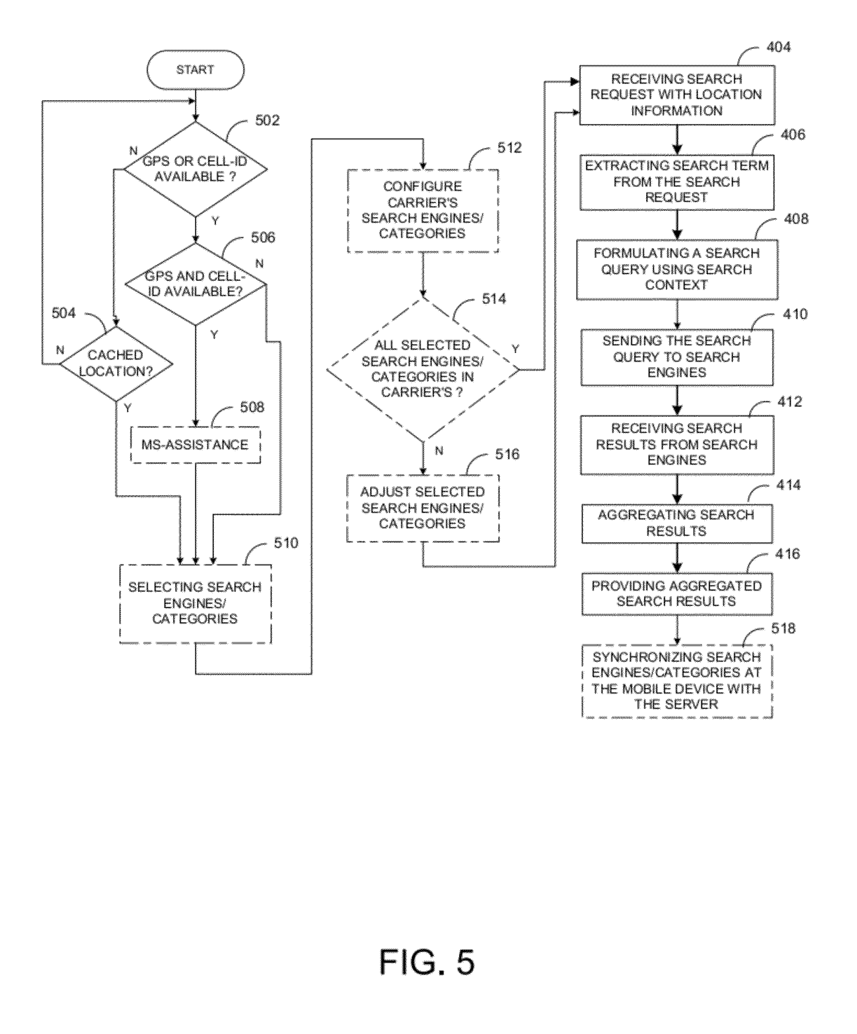

FIG. 5 depicts alternative embodiments of a portion of the flow chart in FIG. 4. If no GPS or other location information for example but not limited to Cell ID is available 502, then the mobile may use cached location 504 or wait until the location information becomes available. If both GPS and Cell-ID information is available 506, other forms' location determination such as MS-assisted technology may be used 508. After the location information is acquired, the user may be presented with a selection of search engines or categories 510. The carrier may dynamically configure the availability of the search engines and categories presented to the user 512. This gives the carrier the ability to easily offer or restrict services to its customers. If all the search engines and the categories selected by the user are supported by the carrier 514, the search request, along with the location information, is forwarded to the server, as described in FIG. 4. If some of the selected search engines are not supported by the carrier, then the search request is adjusted to the search engines and categories supported by the carrier 516 before being sent to the server. In one embodiment, the server also controls the availability of search engines and categories by synchronizing what is available at the mobile device with what is currently supported by the server 518.

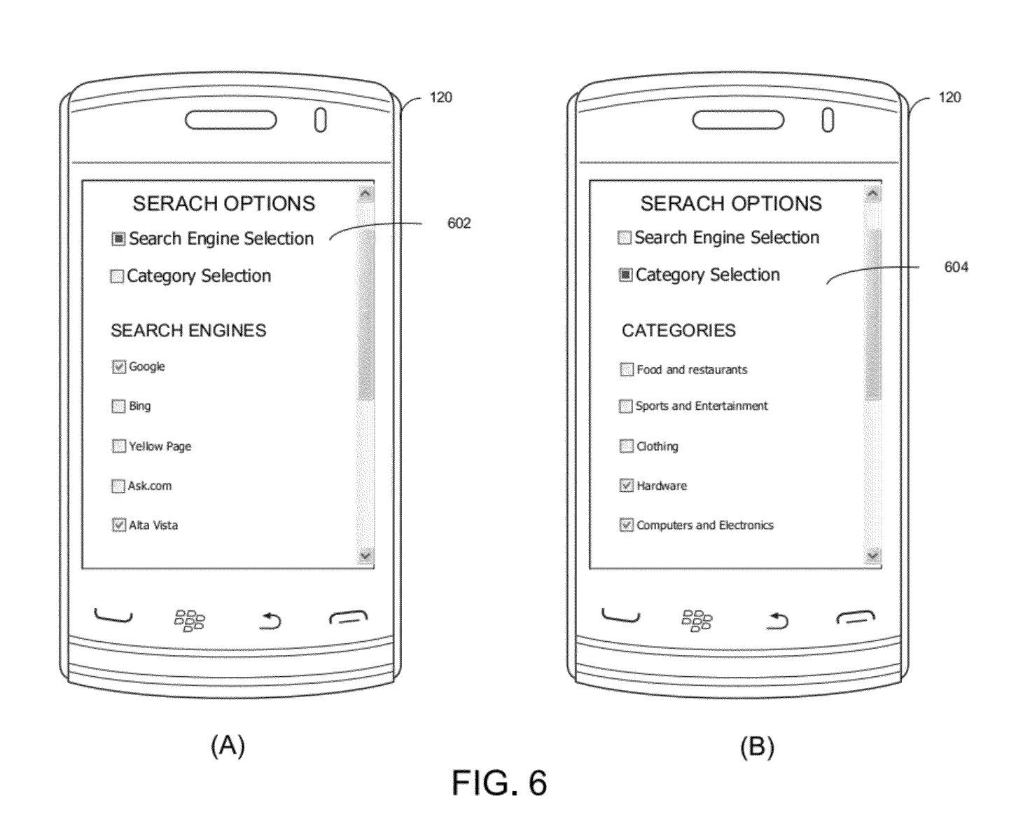

FIG. 6 (A) and (B) are two schematic presentations of the user interface of the mobile device for selecting the search engines and categories, respectively.

The user interface in FIG. 6 (A) illustrates a display having a number of different icons representing the available search engines. The user may select the search engines 602 by checking “Google” and “Alta Vista” as illustrated in FIG. 6 (A). In one embodiment, the search box can be available at all times on the idle screen. In yet another embodiment, the searching is initiated by using a modeless search query implementation such that by typing a search term during idle mode triggers the POI searching. Similarly, the user may also select the categories after checking the “Category Selection” 604 as shown in FIG. 6 (B).

Other means of user input may be used to interact with the mobile device. For example, a mobile device equipped with voice recognition technology may allow its user to enter commands by speaking directly to the device without using a keypad.

Because of privacy concerns relating to disclosing user location to a third party, such as the server, the mobile device may request user authorization before initiating the location determination process.

FIG. 7 is a functional block diagram that illustrates a wireless communications device such as a mobile device on which embodiments of the present disclosure may be implemented. As shown by way of example in FIG. 7, the mobile device, which is designated generally by reference numeral 120, includes a processing unit such as a processor or a microprocessor 702 for executing one or more applications 701, computer readable medium in the form of removable or fixed, volatile or non-volatile or permanent or re-writable computer storage media for example, flash memory 704 and/or RAM 706, for storing one or more applications and related data.

The mobile device 120 may further include a user interface 708 with which the user interacts with the device. The user interface 708 may include a display 710 and an input device 712, 714. The display 710 may be a liquid crystal display (LCD) and/or a touch-sensitive display screen. The input device may include a keyboard 712, thumbboard, or touchscreen 714 that are used to receive data from a user. In addition, input device may also include a plurality of other inputs or controls for adjusting and configuring one or more aspects of the present disclosure including voice commands.

As shown by way of example in FIG. 7, the mobile device 120 includes a radiofrequency (RF) transceiver 716 and associated antenna 718 for wireless communications using any one of known wireless communication protocols. As shown, the transceiver 716 including communication interface may include a plurality of components or operational features that allow the mobile device 120 to transmit search and location data, and retrieve information from the server. The hardware and software necessary for connection to the base station 106 includes, for exemplary purposes only, internal and external components that transmit and receive data wirelessly using a plurality of standard protocols including, for example but not limited to, GSM, CDMA, W-CDMA, Bluetooth, Wi-Fi, IrDA, WiMAX, WiBRO or through other known wireless standards.

For some wireless communication protocols, a SIM card 720 may be provided. Optionally, where the device is a voice-enabled wireless communications device such as, for example, a smart phone or cellular phone, the mobile device 120 may further include a microphone 722 and a speaker 724. The mobile device 120 includes a location based system (LBS) module 726. The LBS module 726 may include various data elements and programs suitable for performing the process and calculations outlined above with respect to obtaining location information of the mobile device 120. For example, the LBS module 726 may correspond to a cellular LBS module, while other components of the interface may correspond to Wi-Fi LBS and traditional GPS or enhanced GPS modules, respectively. The LBS module 726 may also contain cached and/or user provided location information.

In accordance with the embodiments of the present disclosure, the mobile device 120 is configured to provide location information with the POI search request. Accordingly, the mobile device 120 comprises a location-determining subsystem, for example but not limited to, as part of the location based systems (LBS) module 726 or GPS, in communication with a plurality of satellites 122, for determining a current location of the mobile device. The memory 704, 706 and processor 702 are configured to receive current location data from the location-determining subsystem to the location of the mobile device 120.

While the present disclosure is made in conjunction with the specific embodiments, it will be understood that it is not intended to limit the present disclosure to the described embodiments. On the contrary, it is intended to cover alternatives, modifications, and equivalents as may be included within the scope of the present disclosure as defined by the appended claims. In the above description, numerous specific details are set forth in order to provide a thorough understanding of the present disclosure. The present disclosure may be practiced without some or all of these specific details. In other instances, well-known process operations have not been described in detail in order not to unnecessarily obscure the present disclosure.

It is further understood that the use of relational terms such as first and second, and the like, if any, are used solely to distinguish one from another entity, item, or action without necessarily requiring or implying any actual such relationship or order between such entities, items or actions.

The flowchart and block diagrams in the Figures illustrate the architecture, functionality, and operation of possible implementations of systems, methods and computer program products according to various embodiments of the present disclosure. In this regard, each block in the flowchart or block diagrams may represent a module, segment, or portion of code, which comprises one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts, or combinations of special purpose hardware and computer instructions.

Some portions of the detailed description in the above are presented in terms of algorithms and symbolic representations of operations on data bits or binary digital signals within a computer memory. These algorithmic descriptions and representations may be the techniques used by those skilled in the data processing arts to convey the substance of their work to others skilled in the art.

An algorithm is generally, considered to be a self-consistent sequence of acts or operations leading to a desired result. These include physical manipulations of physical quantities. Usually, though not necessarily, these quantities take the form of electrical or magnetic signals capable of being stored, transferred, combined, compared, and otherwise manipulated. It has proven convenient at times, principally for reasons of common usage, to refer to these signals as bits, values, elements, symbols, characters, terms, numbers or the like. It should be understood, however, that all of these and similar terms are to be associated with the appropriate physical quantities and are merely convenient labels applied to these quantities.

Unless specifically stated otherwise, as apparent from the above discussions, it is appreciated that throughout the specification discussions utilizing terms such as “processing,” “computing,” “calculating,” “determining,” or the like, refer to the action and/or processes of a computer or computing system, or similar electronic computing media player device, that manipulate and/or transform data represented as physical, such as electronic, quantities within the computing system's registers and/or memories into other data similarly represented as physical quantities within the computing system's memories, registers or other such information storage, transmit session or display devices.

Embodiments within the scope of the present disclosure can be implemented in digital electronic circuitry, or in computer hardware, firmware, software, or in combinations thereof. Apparatus within the scope of the present disclosure can be implemented in a computer program product tangibly embodied in a machine-readable storage medium for execution by a programmable processor; and method actions within the scope of the present disclosure can be performed by a programmable processor executing a program of instructions to perform functions of the disclosure by operating on input data and generating output. Embodiments within the scope of the present disclosure may be implemented advantageously in one or more computer programs that are executable on a programmable system including at least one programmable processor coupled to receive data and instructions from, and to transmit data and instructions to, a data storage system, at least one input device, and at least one output device. Each computer program can be implemented in a high-level procedural or object oriented programming language, or in assembly or machine language if desired; and in any case, the language can be a compiled or interpreted language. Suitable processors include, by way of example, both general and special purpose microprocessors. Generally, a processor will receive instructions and data from a read-only memory and/or a random access memory. Generally, a computer will include one or more mass storage devices for storing data files. Embodiments within the scope of the present disclosure include computer-readable media for carrying or having computer-executable instructions, computer-readable instructions, or data structures stored thereon. Such computer-readable media may be any available media, which is accessible by a general-purpose or special-purpose computer system. Examples of computer-readable media may include physical storage media such as RAM, ROM, EPROM, CD-ROM or other optical disk storage, magnetic disk storage or other magnetic storage devices, or any other media which can be used to carry or store desired program code means in the form of computer-executable instructions, computer-readable instructions, or data structures and which may be accessed by a general-purpose or special-purpose computer system. Any of the foregoing can be supplemented by, or incorporated in, ASICs (application-specific integrated circuits). It should be understood that embodiments of the present disclosure may be used in a variety of applications. Although the present disclosure is not limited in this respect, the methods disclosed herein may be used in many apparatuses such as in the transmitters, receivers and transceivers of a radio system. Radio systems intended to be included within the scope of the present disclosure include, by way of example only, cellular radiotelephone communication systems, satellite communication systems, two-way radio communication systems, one-way pagers, two-way pagers, personal communication systems (PCS), personal digital assistants (PDA's), notebook computers in wireless local area networks (WLAN), wireless metropolitan area networks (WMAN), wireless wide area networks (WWAN), or wireless personal area networks (WPAN, and the like).

What is claimed is:

1. A method for point-of-interest search comprising:
receiving a search request at a mobile device;
formulating a search query using the search request and a location information;
sending the search query to a search resource selector;
receiving search results; and
displaying the search results.

2. The method according to claim 1, wherein the search resource selector sends the search query to a plurality of search engines.

3. The method according to claim 1, wherein the search resource selector resides in a server, further comprising sending the search query to a plurality of search engines.

4. The method according to claim 1, wherein the location information is included in a search context.

5. The method according to claim 4, further comprising aggregating the search results based on the search context.

6. The method according to claim 4, wherein the search context includes a user selection.

7. The method according to claim 5, further comprising providing aggregated results to the mobile device.

8. The method according to claim 1, wherein the search request is input by a user input.

9. The method according to claim 1, further comprising defining a subset of search engines.

10. The method according to claim 9, wherein the subset of search engines is defined by a carrier.

11. The method according to claim 1, further comprising defining a subset of categories.

12. The method according to claim 1, wherein the search request originates from a client application running on the mobile device.

13. The method according to claim 1, wherein the location information is cached location data.

14. The method according to claim 1, wherein the server complements the search context.

15. A search aggregation server for point-of-interest search comprising:
a location based request receiver receiving a search request, the search request including a location information acquired by a mobile device at a location defined by the location information;
a search resource selector formulating a search query using the search request and the location information;
a search resource provider sending the search query to a plurality of search engines;
a search result interface receiving search results from the plurality of search engines; and
a search result aggregator aggregating the search results based on the search context.

16. The search aggregation server according to claim 15, further comprising an aggregated result provider providing aggregated results to the mobile device.

17. The search aggregation server according to claim 15, further comprising a synchronizer for ensuring search engines and categories currently supported by the server are present at the mobile device.

18. The search aggregation server according to claim 15, wherein the search request is received from a carrier, wherein the carrier configures a subset of the plurality of search engines.

19. The search aggregation server according to claim 15, wherein the search context includes a user selection.

20. A mobile device for point-of-interest search comprising:
a client application accepting a user input and originating a search request, the search request including a location information acquired by a mobile device at a location defined by the location information; and
a transceiver receiving aggregated search results;
wherein the server formulates a search query using the search request and the location information and sends the search query to a plurality of search engines, receives search results from the plurality of search engines; and aggregates the search results.
